(19) United States
(12) Patent Application Publication
(10) Pub. No.: US 2013/0118527 A1
(43) Pub. Date: May 16, 2013

(54) MANDREL BAR CLEANING FACILITY

(71) Applicant: SUMITOMO METAL INDUSTRIES, LTD., Osaka-shi (JP)

(72) Inventors: Kouji Nakaike, Osaka-Shi (JP); Yasuyoshi Hidaka, Osaka-shi (JP); Sumio Iida, Osaka-shi (JP)

(73) Assignee: SUMITOMO METAL INDUSTRIES, LTD., Osaka-shi (JP)

(21) Appl. No.: 13/735,693

(22) Filed: Jan. 7, 2013

Related U.S. Application Data
(62) Division of application No. 12/377,315, filed on Jun. 29, 2010.

(30) Foreign Application Priority Data
Aug. 22, 2006 (JP) 2006-224812

(51) Int. Cl. B08B 3/02

(52) U.S. Cl. CPC B08B 3/022
USPC 134/15

(57) ABSTRACT

It is an object of the present invention to provide a mandrel bar cleaning facility capable of effectively suppressing carburization generated on the inner surface of a pipe or tube while the pipe or tube is elongated and rolled without hindering an operation.

A mandrel bar cleaning facility of the present invention cleans a mandrel bar B which is pulled out of a mandrel bar conveying line after being used for elongating and rolling a pipe or tube in a mandrel mill. The mandrel bar cleaning facility is provided with conveying devices that convey the mandrel bar B in the axial direction while revolving the mandrel bar B in the peripheral direction, and cleaning devices that are arranged oppositely to the side of the mandrel bar B conveyed by the conveying devices and jet high-pressure water having a water pressure of 0.2 to 150 MPa (preferably, 20 to 150 MPa) toward the outer surface of the mandrel bar B.

### TECHNICAL FIELD

The present invention relates to a mandrel bar cleaning facility which cleans a mandrel bar used for producing a seamless pipe or tube. Specifically, the present invention relates to a mandrel bar cleaning facility capable of suppressing carburization generated on the inner surface of a pipe or tube elongated and rolled without hindering an operation. Hereinafter, “pipe or tube” is referred to as “pipe” when deemed appropriate.

### BACKGROUND ART

In the production of the seamless pipe due to a Mannesmann-mandrel mill method, first, a round billet or a square billet is heated at 1200 to 1260° C. in a heating furnace, and the billet is then pierced and rolled by a piercer to produce a hollow shell. Next, a mandrel bar is inserted into the inner surface of the hollow shell, and the hollow shell is elongated and rolled by a mandrel mill to produce a pipe reduced to a prescribed thickness. After the mandrel bar is then extracted from the pipe having the reduced thickness, the pipe is roll-formed to a prescribed outer diameter by a sizing mill to produce a seamless pipe as a product.

The mandrel bar and the hollow shell tube tend to be seized while the hollow shell is elongated and rolled. A lubricant is applied to the surface of the mandrel bar in order to prevent the seizing. A graphite-based lubricant containing graphite excellent in wear resistance characteristic or seizing resistance characteristic is mainly used as the lubricant. Essentially, the lubricant applied to the surface of the mandrel bar is dried, and the mandrel bar is then conveyed to the mandrel mill on a conveying line on which a conveying device including, for example, a conveying roll or the like is provided while being brought into contact with the conveying device, and is used for elongating and rolling the hollow shell. However, in the actual producing process, time for completely drying the lubricant cannot be ensured in many cases. Thereby, the lubricant which is not dried drips while conveying the mandrel bar, and adheres to the conveying device located below the mandrel bar. Even when the lubricant is completely dried and the mandrel bar is then conveyed, the membrane of the lubricant is dropped out or scaled off by vibration or the like generated upon conveying the mandrel bar to adhere to the conveying device. Thereby, the conveying device arranged on the mandrel bar conveying line is always polluted by the graphite contained in the adhering lubricant. Thus, since the conveying device arranged on the mandrel bar conveying line is polluted by the graphite, the mandrel bar conveyed while being brought into contact with the conveying device is also polluted by the graphite.

When the hollow shell made of low carbon steel having carbon content of 0.04% by mass or less such as SUS 304L is elongated and rolled using the mandrel bar polluted by the graphite as described above, the inner surface of the pipe elongated and rolled is inevitably carburized.

As a measure for preventing the carburization of the inner surface of the pipe, it is considered to apply a non-graphite-based lubricant to the surface of the mandrel bar. However, since the non-graphite-based lubricant is generally more expensive than the graphite-based lubricant, it is difficult to use the non-graphite-based lubricant for the hollow shell of any steel grade such as common steel in view of economic efficiency. It is also difficult to provide the conveying line using only the non-graphite-based lubricant for elongating and rolling the hollow shell made of low carbon steel in view of economic efficiency since it requires new facility investment. Thereby, a measure is mainly carried out, which shares the mandrel bar conveying line also using the graphite-based lubricant even when the hollow shell of low carbon steel is elongated and rolled, and cleans the mandrel bar or the conveying device arranged on the mandrel bar conveying line and then applies the non-graphite-based lubricant to the surface of the mandrel bar when the hollow shell made of low carbon steel is elongated and rolled (for example, see Japanese Patent Application Laid-Open Nos. 2002-28705 and 2000-24706).

The graphite-based lubricant adhering to the surface of the mandrel bar may be not sufficiently cleaned only when cleaning the mandrel bar on the conveying line since the cleaning needs to be completed comparatively in a short time in view of operation efficiency, and may remain when being used for elongating and rolling the hollow shell. Therefore, when the mandrel bar is pulled out of the conveying line, and is carried again in the conveying line to apply the non-graphite-based lubricant to the mandrel bar after the mandrel bar to which the graphite-based lubricant is applied is used for elongating and rolling the hollow shell, it is effective to previously sweep the surface of the mandrel bar to which the graphite-based lubricant adheres before the mandrel bar is again carried in the conveying line (off-line sweeping).

The conventional off-line sweeping is manually carried out by a worker using a sweeping tool such as a brush, or is carried out by rubbing the surface of the mandrel bar with a rotary brush.

However, the sweeping efficiency is not good in both the case of the manual work carried out by the worker and the case of rubbing the surface with the rotary brush. That is, since a long time is required for sufficiently removing the graphite-based lubricant adhering to the surface of the mandrel bar so that the carburization of the inner surface of the pipe does not become problems, the cases may hinder an operation.

On the other hand, Japanese Patent Application Laid-Open No. 2002-28705 describes that a graphite-based lubricant adhering to a mandrel bar is cleaned by water in off line. However, the specific cleaning method is not disclosed at all.

### DISCLOSURE OF THE INVENTION

The present invention has been made to eliminate the problem of the conventional technique. It is an object of the present invention to provide a mandrel bar cleaning facility capable of effectively suppressing carburization generated on the inner surface of a pipe or tube while the pipe or tube is elongated and rolled without hindering an operation.

In order to achieve the above-mentioned object, the present invention provides a mandrel bar cleaning facility which cleans a mandrel bar pulled out of a mandrel bar conveying line after being used for elongating and rolling a pipe or tube in a mandrel mill, comprising: a conveying device for conveying the mandrel bar in an axial direction of the mandrel bar while revolving the mandrel bar in a peripheral direction of the mandrel bar; and a cleaning device arranged oppositely to a side of the mandrel bar conveyed by the conveying device, the cleaning device jetting high-pressure water having a water pressure of 0.2 to 150 MPa toward an outer surface of the mandrel bar.

Preferably, the high-pressure water has a water pressure of 20 to 150 MPa.

According to the mandrel bar cleaning facility according to the present invention, the graphite-based lubricant adhering to the surface of the mandrel bar can be removed for a short time so that the carburization of the inner surface of the pipe or tube does not become problems. Therefore, the mandrel bar conveying line also using the graphite-based lubricant can be shared for a case of elongating and rolling a hollow shell made of low carbon steel and the carburization generated on the inner surface of the pipe or tube upon elongating and rolling the pipe or tube can be effectively suppressed without hindering the operation.

### BRIEF DESCRIPTION OF THE DRAWINGS

FIG. 1 is an illustration schematically showing a production line of a seamless pipe or tube having a mandrel bar cleaning facility (off-line cleaning facility) according to the present invention.

FIG. 2 is an illustration showing the schematic configuration of the off-line cleaning facility according to the present invention.

FIG. 3 is an illustration showing the schematic configuration of a rubbing device used for a conventional off-line sweeping.

FIG. 4 is an illustration showing the schematic configuration of a conveying line cleaning device.

FIG. 5 (FIG. 5A and FIG. 5B) are illustrations showing the schematic configuration of the mandrel bar cleaning facility (on-line cleaning facility) in which FIG. 5A is a front view of the on-line cleaning facility, and FIG. 5B is an illustration showing the arrangement of the on-line cleaning facility.

### BEST MODE FOR CARRYING OUT THE INVENTION

Hereinafter, one embodiment of the present invention will be described with reference to the accompanying drawings. In this embodiment, the following case will be described as an example. A mandrel bar having a surface to which a graphite-based lubricant is applied and used for elongating and rolling is pulled out of a mandrel bar conveying line (hereinafter, suitably referred to as “conveying line”). The mandrel bar is cleaned in a mandrel bar cleaning facility (hereinafter, suitably referred to as “off-line cleaning facility”) according to the present invention. The mandrel bar is then again carried in the conveying line to apply a non-graphite-based lubricant to the surface of the mandrel bar, and a hollow shell made of low carbon steel is elongated and rolled.

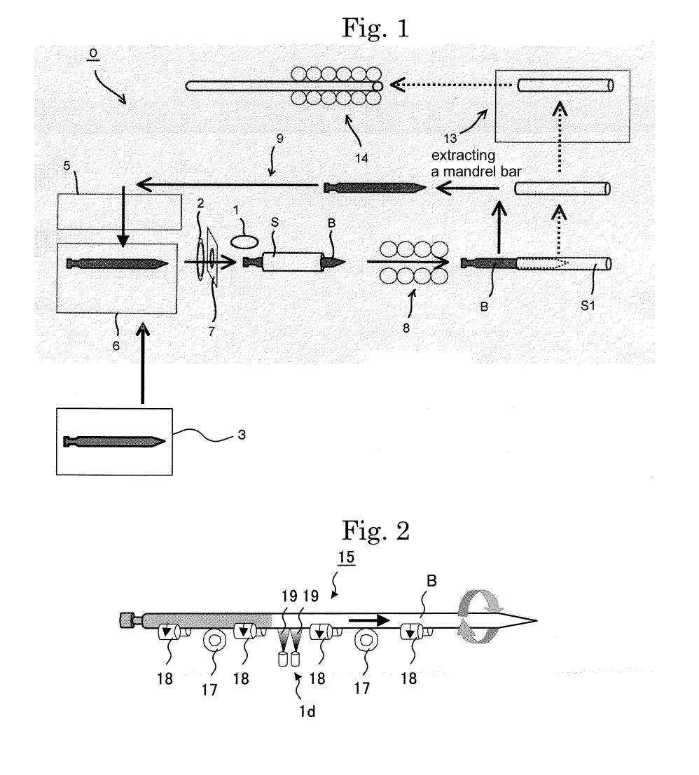

FIG. 1 is an illustration schematically showing a production line of a seamless pipe having an off-line cleaning facility according to the present invention.

First, a process will be described, which applies the graphite-based lubricant to the surface of a mandrel bar B, and elongates and rolls a hollow shell S to produce a pipe S1. As shown in FIG. 1, the graphite-based lubricant is applied to the surface of the mandrel bar B carried in the conveying line from a carrying-in table 6 by a lubricant applicator 7. Then, the mandrel bar B is inserted into the hollow shell S pierced and rolled by a piercer (not shown) in the course of the conveying line to an entrance of a mandrel mill 8. The hollow shell S is elongated and rolled by the mandrel mill 8 to form the pipe S1. The elongation rolling of the hollow shell S in the mandrel mill 8 is completed, and the mandrel bar B is then pulled out, conveyed on a return line 9, and is cooled in a water-cooling apparatus 5. The mandrel bar B is then cleaned in the mandrel bar cleaning facility (hereinafter, suitably referred to as “on-line cleaning facility”) 2 arranged on the conveying line, and the graphite-based lubricant is then again applied to the surface of the mandrel bar B by the lubricant applicator 7. The mandrel bar B is used for elongating and rolling at the second pass or later in the same process as that described above. The mandrel bar B is used circulately for elongating and rolling the hollow shell S in the mandrel mill 8 as described above. In this circulation use, a conveying device (not shown) arranged in the conveying line for the mandrel bar B is polluted by graphite contained in the graphite-based lubricant.

The pipe S1 elongated and rolled in the mandrel mill 8 is reheated for about 20 to about 35 minutes at about 940° C. to about 1060° C. in a reheating furnace 13. The pipe S1 is finished to a product dimension by a stretch reducer 14 to produce a seamless pipe.

Next, a process will be described, which applies the non-graphite-based lubricant to the surface of the mandrel bar B, and elongates and rolls the hollow shell S to produce the pipe S1 made of low carbon steel. The mandrel bar B having the surface to which the graphite-based lubricant is applied as described above and used for elongating and rolling is pulled out of the conveying line, and is cleaned in the off-line cleaning facility according to the present invention. For example, the off-line cleaning facility is set in a bar warehouse 3 for housing the mandrel bar B separated from a production line 0 of the seamless pipe.

FIG. 2 is an illustration showing the schematic configuration of the off-line cleaning facility according to the present invention.

As shown in FIG. 2, the off-line cleaning facility 15 comprises: a conveying device for conveying the mandrel bar B in an axial direction of the mandrel bar B while revolving the mandrel bar B in a peripheral direction of the mandrel bar B; and a cleaning device arranged oppositely to a side of the mandrel bar B conveyed by the conveying device, the cleaning device jetting high-pressure water toward an outer surface of the mandrel bar B.

The conveying device according to the embodiment includes conveying rolls 17 and skew rolls 18 that support the mandrel bar B. The conveying rolls 17 are revolved to convey the mandrel bar B in the axial direction, and the skew rolls 18 are revolved to revolve the mandrel bar B in the peripheral direction. Therefore, the conveying rolls 17 and the skew rolls 18 are revolved to convey the mandrel bar B in the axial direction while revolving the mandrel bar B in the peripheral direction.

The cleaning device according to the embodiment is provided with two cleaning nozzles 1d arranged below the mandrel bar B. Since cleaning nozzles 1d are arranged below, a distance between the cleaning nozzle 1d and the surface of the mandrel bar B can be made constant in spite of the outer diameter of the mandrel bar B. When the conveying rolls 17 and the skew rolls 18 are revolved while high-pressure water 19 is jetted toward the outer surface of the mandrel bar B from two cleaning nozzles 1d, it is possible to clean the whole surface of the mandrel bar B. The distance between the cleaning nozzle 1d and the surface of the mandrel bar B is set to about several hundreds millimeters. The spread angle of the high-pressure water 19 jetted from the each cleaning nozzle 1d is set to 10 degrees to 20 degrees.

The water pressure of the high-pressure water jetted from the cleaning nozzle 1d is set to 0.2 to 150 MPa (preferably, 20 to 150 MPa). Hereinafter, this reason will be described.

The water pressure of the high-pressure water jetted from the each cleaning nozzle 1d of the off-line cleaning facility 15 was suitably changed, and the cleaning test of the mandrel bar B having the surface to which the graphite-based lubricant sufficiently adhered was carried out. Specifically, the cleaning tests of both a case where the graphite-based lubricant containing an organic binder (vinyl acetate and an acrylic resin or the like) for ensuring the adhesion and storage stability of the lubricant in comparatively high content adheres and a case where the graphite-based lubricant containing the organic binder in low content adheres were carried out. Generally, the lubricant containing a large amount of the organic binder to be added exhibits water resistance, and it tends to be difficult to clean the lubricant. The lubricant containing a small amount of the organic binder to be added exhibits non-water resistance (water solubility), and tends to be easily cleaned. The mandrel bar B was cleaned while the conveying speed of the mandrel bar B was suitably changed (the cleaning time per one of the mandrel bars was changed). An object adhering to the surface of the cleaned mandrel bar B was analyzed to obtain a carbon deposition amount (g/m²) remaining on the surface of the mandrel bar B. As usual, an oxidization membrane provided for the prevention of seizing existed on the surface of the mandrel bar B used in this cleaning test. The state of the cleaned oxidization membrane was confirmed by surface micro observation.

Table 1 shows a part of the results of the cleaning test described above.

TABLE 1

| | | Efficiency | | | |
|---|---|---|---|---|---|
| Water | | (cleaning | | | |
| pressure | | time) | | | |
| of high- | | (minutes | Carbon | | |
| pressure | | per one | deposition | | |
| water | Lubricant | mandrel | amount | State of | Overall |
| (MPa) | component | bar) | (g/m²) | membrane | evaluation |
| 0.1 | Less | 20.0 | 45.3 | FINE | POOR |
| | organic | | | | |
| | binder | | | | |
| 0.2 | Less | 4.0 | 5.8 | FINE | GOOD |
| | organic | | | | |
| | binder | | | | |
| | More | 20.0 | 62.4 | FINE | POOR |
| | organic | | | | |
| | binder | | | | |
| 20 | More | 6.5 | 12.8 | FINE | VERY |
| | organic | | | | GOOD |
| | binder | | | | |
| 30 | More | 6.5 | 6.7 | FINE | VERY |
| | organic | | | | GOOD |
| | binder | | | | |
| 50 | More | 2.5 | 4.8 | FINE | VERY |
| | organic | | | | GOOD |
| | binder | | | | |
| 70 | More | 2.5 | 4.2 | FINE | VERY |
| | organic | | | | GOOD |
| | binder | | | | |
| 90 | More | 2.5 | 2.2 | FINE | VERY |
| | organic | | | | GOOD |
| | binder | | | | |
| 150 | More | 2.5 | 1.3 | Partial | GOOD |
| | organic | | | peeling | |
| | binder | | | | |
| 160 | More | 2.5 | 1.5 | Peeling | POOR |
| | organic | | | | |
| | binder | | | | |

As shown in Table 1, the graphite-based lubricant remaining on the surface of the mandrel bar B could be sufficiently reduced (carbon deposition amount: less than 30 g/m²) so that the carburization of the inner surface of the pipe S1 did not become problems for the cleaning time (less than 10 minutes per one mandrel bar) without hindering an operation by setting the water pressure of the high-pressure water jetted from the cleaning nozzles 1d to 20 to 150 MPa.

When the water pressure of the high-pressure water was set to 0.2 MPa or more and less than 20 MPa, the remaining graphite-based lubricant could not be sufficiently reduced (the carbon deposition amount: 30 g/m² or more) even when the cleaning time was set to 20 minutes per one mandrel bar which was out of an allowable range in the mandrel bar B to which the graphite-based lubricant containing the organic binder in high content adhered. On the other hand, even when the water pressure of the high-pressure water was set to 0.2 MPa or more and less than 20 MPa in the mandrel bar B to which the graphite-based lubricant containing the organic binder in low content adhered, both the cleaning time and the carbon deposition amount could be set within the allowable range (the cleaning time: less than 10 minutes per one mandrel bar, the carbon deposition amount: less than 30 g/m²). When the lubricant containing the organic binder in low content and having non-water resistance is used, even the lubricant applied to the surface of the mandrel bar B is flown down by the drop of cooling water sprayed on a mill roll just before the start of the elongation rolling and water droplet dripped from the mill roll if the hollow shell S is frequently elongated and rolled by the mandrel mill 8 for a fixed time (for example, the hollow shell S is elongated and rolled every 15 to 30 seconds). Thereby, the mandrel bar B and hollow shell S may be seized while the hollow shell S is elongated and rolled. Therefore, the lubricant having non-water resistance is not preferably used for the hollow shell S of a steel grade frequently elongated and rolled and the production line 0 frequently elongating and rolling the hollow shell S. The lubricant containing the organic binder in high content and having water resistance is preferably used. Therefore, as described above, the water pressure of the high-pressure water is preferably set to 20 MPa or more. However, even when the lubricant having non-water resistance is used for the hollow shell S of a steel grade infrequently elongated and rolled and the production line 0 that infrequently elongating and rolling the hollow shell S (for example, the hollow shell S is elongated and rolled every 60 seconds), the mandrel bar B and the hollow shell S may not be seized while the hollow shell S is elongated and rolled. Therefore, the water pressure of the high-pressure water, which may not be necessarily set to 20 MPa or more, may be set to 0.2 MPa or more.

On the other hand, as shown in Table 1, when the water pressure of the high-pressure water was set to less than 0.2 MPa, the remaining graphite-based lubricant could not be sufficiently reduced for the cleaning time of the allowable range in even the mandrel bar B to which the lubricant having non-water resistance adhered. When the high-pressure water having a water pressure higher than 150 MPa was jetted, the oxidization membrane formed on the surface of the mandrel bar B was peeled.

For these reasons, the water pressure of the high-pressure water jetted from the cleaning nozzles 1d is set to 0.2 to 150 MPa (preferably, 20 to 150 MPa).

A test was also carried out, which compared the efficiency of the cleaning of the surface of the mandrel bar B carried out by the off-line cleaning facility 15 described above with that of the sweeping of the surface of the mandrel bar B carried out by a rubbing device using the conventional rotary brush. The graphite-based lubricant containing the organic binder in high content and having water resistance was made to adhere to the surface of the mandrel bar B before the test.

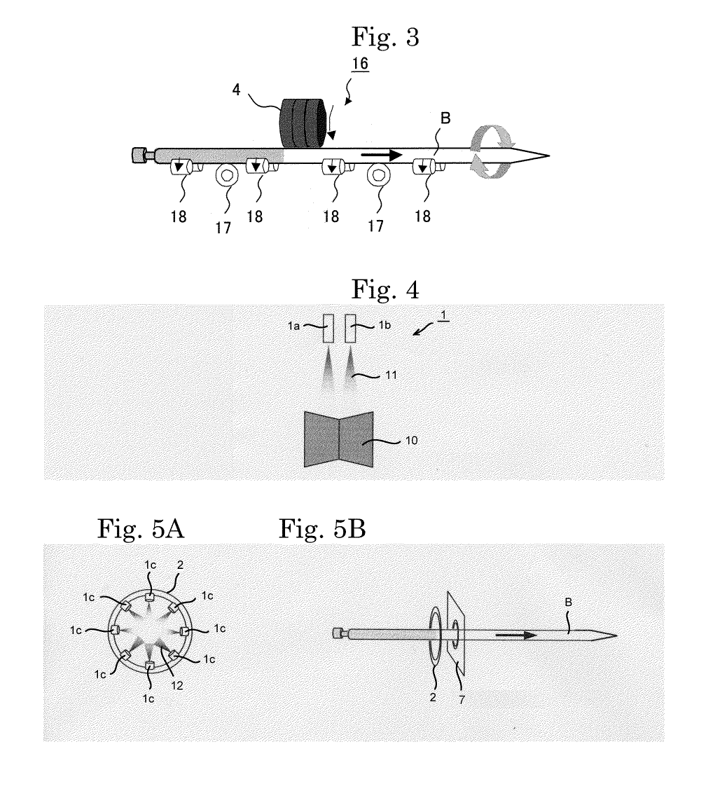

FIG. 3 is an illustration showing the schematic configuration of a rubbing device used for the conventional off-line sweeping used for the test.

As shown in FIG. 3, a rubbing device 16 is provided with the conveying rolls 17, the skew rolls 18 that support the mandrel bar B, and a rotary brush 4 that is arranged so as to be brought into contact with the mandrel bar B. While the rotary brush 4 is revolved, the skew rolls 18 are revolved to revolve the mandrel bar B in the peripheral direction and the conveying rolls 17 are revolved to convey the mandrel bar B in the axial direction. Thereby, the rotary brush 4 can rub the whole surface of the mandrel bar B to clean the surface of the mandrel bar B.

Table 2 shows the results of the test.

TABLE 2

| | Water | Cleaning/ | | |
|---|---|---|---|---|
| | pressure | sweeping | | |
| | of high- | time (minutes | Carbon | |
| Sweeping | pressure | per one | deposition | |
| (cleaning) | water | mandrel | amount | Overall |
| facility | (MPa) | bar) | (g/m²) | evaluation |
| Rubbing | — | 5.0 | 58.1 | POOR |
| device | | 15.0 | 2.3 | POOR |
| Off-line | 30 | 6.5 | 6.7 | VERY |
| cleaning | | | | GOOD |
| facility | 70 | 2.5 | 4.2 | VERY |
| | | | | GOOD |
| | 150 | 2.5 | 1.3 | VERY |
| | | | | GOOD |

As shown in Table 2, when the conventional rubbing device 16 was used, the graphite-based lubricant (the carbon deposition amount) remaining on the surface of the mandrel bar B could not be sufficiently reduced for the sweeping time (5 minutes per one mandrel bar) without hindering an operation so that the carburization of the inner surface of the pipe S1 did not become problems. In order to sufficiently reduce the graphite-based lubricant remaining on the surface of the mandrel bar B, the sweeping time needs to be set to no less than 10 minutes per one mandrel bar which is out of the allowable range, thereby causing operational problems. On the other hand, according to the off-line cleaning facility 15, the graphite-based lubricant remaining on the surface of the mandrel bar B could be sufficiently reduced (the carbon deposition amount: less than 30 g/m²) so that the carburization of the inner surface of the pipe S1 did not become problems for the cleaning time (less than 10 minutes per one mandrel bar) without hindering an operation as in that described with reference to Table 1.

The mandrel bar B cleaned by the off-line cleaning facility 15 as described above is again carried in the conveying line from the carrying-in table 6. It is preferable that the conveying device arranged at least between the lubricant applicator 7 set on the conveying line of the mandrel bar B and the entrance of the mandrel mill 8 is previously cleaned before the mandrel bar B is again carried in.

FIG. 4 is an illustration showing the schematic configuration of the conveying line cleaning device 1 used for cleaning the conveying rolls constituting the conveying device.

As shown in FIG. 4, the conveying line cleaning device 1 is provided with two cleaning nozzles 1a, 1b arranged at a position separated above by about several hundreds millimeters from the surface of a conveying roll 10. The conveying roll 10 is cleaned by jetting high-pressure water 11 toward the conveying roll 10 from the cleaning nozzles 1a, 1b while the conveying roll 10 is revolved. It is preferable that the spread angle of the high-pressure water 11 jetted from each of the cleaning nozzles 1a, 1b is set to 10 degrees to 20 degrees, and the water pressure of the high-pressure water 11 is set to 30 to 150 MPa.

As described above, the conveying device arranged on the mandrel bar conveying line is previously cleaned, and the mandrel bar B is then again carried in the conveying line from the carrying-in table 6. The non-graphite-based lubricant is applied to the surface of the carried mandrel bar B by the lubricant applicator 7. Then, the mandrel bar B is inserted into the hollow shell S made of low carbon steel in the course of the conveying line to an entrance of a mandrel mill 8. The hollow shell S is elongated and rolled by the mandrel mill 8 to form the pipe S1. The elongation rolling of the hollow shell S in the mandrel mill 8 is completed, and the mandrel bar B is then pulled out, conveyed on a return line 9, and is cooled in a water-cooling apparatus 5. The mandrel bar B is then cleaned in the on-line cleaning facility 2 arranged on the conveying line.

FIG. 5 (FIG. 5A and FIG. 5B) are illustrations showing the schematic configuration of the on-line cleaning facility 2 in which FIG. 5A is a front view of the on-line cleaning facility 2, and FIG. 5B is an illustration showing the arrangement of the on-line cleaning facility 2.

As shown in FIG. 5, the on-line cleaning facility 2, which is arranged on the upstream side of the lubricant applicator 7, cleans the mandrel bar B used for elongating and rolling the hollow shell. The on-line cleaning facility 2 is provided with a total of eight cleaning nozzles 1c circularly provided so that the maximum distance between the cleaning nozzles 1c and the mandrel bar B is set to about several hundreds millimeters. The surface of the mandrel bar B is cleaned by jetting high-pressure water 12 toward the mandrel bar B from each of the cleaning nozzles 1c. It is preferable that the spread angle of the high-pressure water 12 jetted from each of the cleaning nozzles 1c is set to 10 degrees to 20 degrees, and the water pressure of the high-pressure water 12 is set to 30 to 150 MPa.

The mandrel bar B is cleaned by the on-line cleaning facility 2 as described above, and the non-graphite-based lubricant is then again applied to the surface of the mandrel bar B by the lubricant applicator 7. The mandrel bar B is used for elongating and rolling the hollow shell S made of low carbon steel at the second pass or later in the same process as that described above.

Table 3 shows results obtained by evaluating the carburization situation of the inner surface of the seamless pipe made of low carbon steel produced by the process described above, and the carburization situation of the inner surface of the seamless pipe made of low carbon steel produced without carrying out the off-line cleaning of the mandrel bar B by the off-line cleaning facility 15. In the evaluation of the carburization situation, samples for analysis were respectively cut from the inner surface of the seamless pipe elongated and rolled at the second pass by the mandrel mill 8 in conditions 1, 3, and from the inner surface of the seamless pipe elongated and rolled at the first pass (therefore, no on-line cleaning of the mandrel bar B) in conditions 2, 4. The carbon concentration of each of the samples was measured by Quantvac (emission spectral analysis). A case where the carbon concentration was equal to or lower than that of the material of the seamless pipe (no carburization) was defined as very good. A case where the increasing amount of the carbon concentration was 0.001 to 0.01% (the allowable range) was defined as good. A case where the carbon concentration increased over 0.01% was defined as poor. The cases were respectively evaluated.

TABLE 3

| | | | Conveying | | |
|---|---|---|---|---|---|
| | Off-line | On-line | line | Carburization | |
| | cleaning | cleaning | cleaning | situation | Note |
| Condition | Presence | Presence | Presence | VERY | Present |
| 1 | | | | GOOD | invention |
| Condition | Presence | Absence | Presence | GOOD | Present |
| 2 | | | | | invention |
| Condition | Absence | Presence | Presence | POOR | Comparative |
| 3 | | | | | example |
| Condition | Absence | Absence | Presence | POOR | Comparative |
| 4 | | | | | example |

As shown in Table 3, the carburization was generated in the seamless pipe produced without carrying out the off-line cleaning of the mandrel bar B. On the other hand, the carburization could be suppressed to a degree practically out of the problem regardless of presence/absence of the cleaning by the on-line cleaning facility 2 in the seamless pipe produced by carrying out the off-line cleaning of the mandrel bar B by the off-line cleaning facility 15.

1. A mandrel bar cleaning method which cleans a mandrel bar pulled out of a mandrel bar conveying line after being used for elongating and rolling a pipe or tube in a mandrel mill, comprising the steps of:
conveying the mandrel bar in an axial direction of the mandrel bar while revolving the mandrel bar in a peripheral direction of the mandrel bar; and
jetting high-pressure water having a water pressure of 20 to 150 MPa toward an outer surface of the conveyed mandrel bar from a position opposite to a side of the mandrel bar to clean the surface of the mandrel bar to which a graphite-based lubricant containing an organic binder and having water resistance adheres.
